(19) United States
(12) Patent Application Publication
(10) Pub. No.: US 2011/0137795 A1
(43) Pub. Date: Jun. 9, 2011

(54) AUTOMATED TELLER MACHINE SYSTEM

(75) Inventors: Anant Nambiar, Larchmont, NY (US); Kevin Carroll, Brookfield, CT (US)

(73) Assignee: MASTERCARD INTERNATIONAL, INC., Purchase, NY (US)

(21) Appl. No.: 12/630,157

(22) Filed: Dec. 3, 2009

(51) Int. Cl. G06Q 40/00; G07F 19/00

(52) U.S. Cl. 705/43; 235/379

(57) ABSTRACT

Exemplary embodiments are directed to processing Automated Teller Machine (ATM) transactions. A transaction request can be received from an ATM. The transaction request can include account information read from a transaction card and a transaction request. The account information corresponds to a first account. The transaction request is incapable of being processed using the first account for which the transaction card was issued. A second account belonging to the account holder of the first account can be identified and can be a different type of account than the first account. The transaction request is capable of being processed using the second account. The transaction request can be processed using the second account to perform the ATM transaction requested.

### BACKGROUND

Automated Teller Machines (ATMs) provide an interface that allows credit card and debit card users to receive and/or deposit funds. Credit cards typically allow account holders to receive a cash advance against a credit line of the credit card account using an ATM. That is, credit card users borrow money against a credit line provided by their credit card account. Debit cards function in a similar manner as credit cards, but instead of drawing against a credit line, the account holder draws against their own money already deposited in a demand deposit account maintained by a financial institution, such as a bank, using an ATM.

While ATMs provide a convenient mechanism for interfacing with accounts associated with credit cards and accounts associated with debit cards, conventional ATM systems limit ATM transactions that can be performed based on whether the user presents a credit card or a debit card. Such limitations typically require a user to use a debit card to perform one set of transactions and a credit card to perform another set of transactions at the ATM.

### SUMMARY

In one aspect, a method of processing an Automated Teller Machine (ATM) transaction is disclosed. The method includes receiving a transaction request from an ATM. The transaction request includes account information read from a transaction card by the ATM and a request to perform an ATM transaction. The account information corresponds to a first account. The transaction request is incapable of being processed using the first account for which the transaction card was issued. The method also includes identifying a second account. The second account is a different type of account than the first account. The transaction request is capable of being processed using the second account. The method further includes processing the transaction request using the second account to perform the ATM transaction requested.

In another aspect, a computer readable medium that stores instructions executable by a computing system, which includes at least one computing device, wherein execution of the instructions a method for processing an Automated Teller Machine (ATM) transaction is disclosed. The method implemented by the execution of the instructions includes receiving a transaction request from an ATM and identifying a second account. The transaction request includes account information read from a transaction card by the ATM and a request to perform an ATM transaction. The account information corresponds to a first account. The transaction request is incapable of being processed using the first account for which the transaction card was issued. The second account is a different type of account than the first account, the transaction request is capable of being processed using the second account. The method implemented by the execution of the instructions further includes processing the transaction request using the second account to perform the ATM transaction requested.

In yet another aspect, a system for processing an Automated Teller Machine (ATM) transaction is disclosed. The system can include a payment network having at least one debit switch. The debit switch is configured to receive a transaction request from an ATM. The transaction request includes account information read from a transaction card by the ATM and a request to perform an ATM transaction. The account information corresponds to a first account. The transaction request is incapable of being processed using the first account for which the transaction card was issued. The debit switch is also configured to identify a second account. The second account is a different type of account than the first account. The transaction request is capable of being processed using the second account. The debit switch is further configured to forwarding the request to a financial institution network associated with the second account.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 depicts an exemplary ATM transaction system in accordance.

FIG. 2 is a block diagram of an exemplary embodiment of a debit switch.

FIGS. 3-9 are flowcharts illustrating ATM transactions that can be implemented.

### DETAILED DESCRIPTION OF PREFERRED EMBODIMENTS

Exemplary embodiments are directed to an Automated Teller Machine (ATM) transaction system configured to facilitate non-traditional ATM transactions. In some embodiments, the ATM transaction system can allow a debit card holder to engage in a cash advance transaction against a credit line without requiring a credit card to be read by the ATM. In some embodiments, the ATM transaction system can allow a credit card holder to engage in a cash withdrawal from a demand deposit account without requiring a debit card to be read by the ATM.

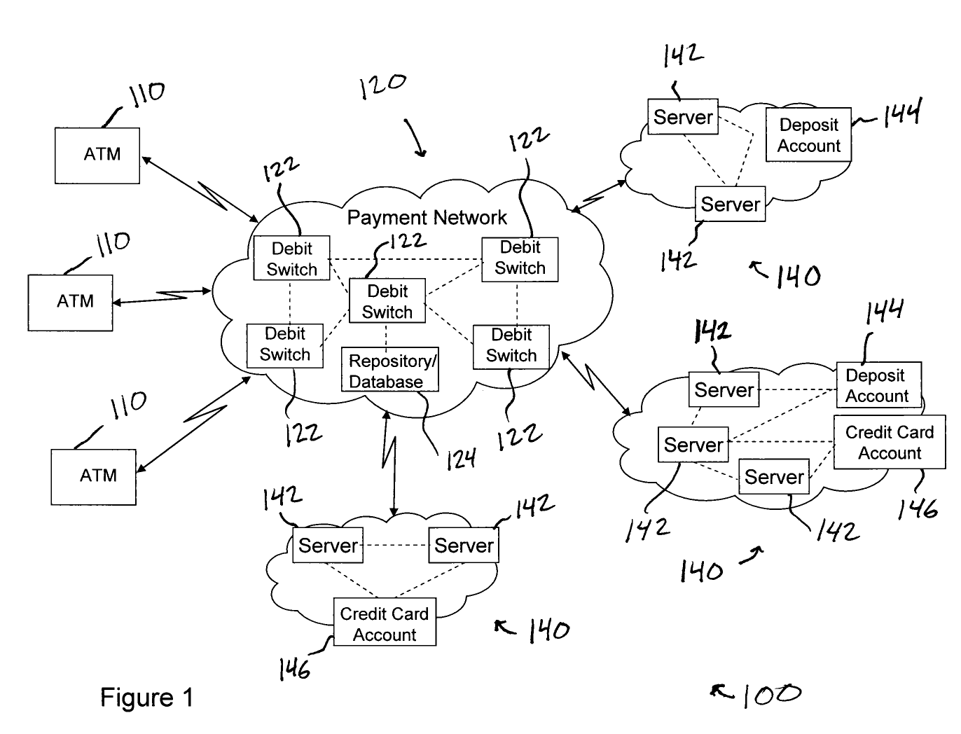

FIG. 1 depicts an ATM transaction system 100 (hereinafter “system 100”) that includes ATM terminals 110 (hereinafter “ATMs 100”), a payment network 120, and financial institution networks 140. The system 100 can facilitate ATM transactions initiated by users of the ATMs 110. For example, a user can present a transaction card to be read at one of the ATMs 110 and can interface with the ATM to carry out transactions for receiving funds dispensed from the ATM, depositing funds into the ATM, receiving balance or statement information, electronic transfers of funds between accounts, and the like.

Transaction cards can be debit cards and credit cards having account information embedded therein. The account information can include a card number, the account holder's name, a security code, and the like. A debit card is a transaction card issued for a demand deposit account. A credit card is a transaction card issued for a credit card account. Debit cards and credit cards can be formed using, for example, a plastic card with a magnetic stripe embedded with account information disposed thereon. The magnetic strips can be swiped at the ATM to allow the ATM to read the account information from the transaction cards.

The ATMs 110 can be configured to facilitate ATM transactions via the payment network 120 and the financial institution networks 140. The ATMs 110 read account information from transaction cards. To ensure that the user has authorization to perform transactions at the ATM, the ATM can request the user to enter a personal identification number (PIN). The ATM can be configured to allow a user to submit transaction requests including cash withdrawals from accounts, cash or check deposits into accounts, fund transfers between accounts, balance inquiries for accounts, cash advances from accounts, and the like. A cash withdrawal refers to drawing against funds currently available in a demand deposit account such that the amount of funds debited or drawn from the account is subtracted from the account total reducing the amount of available funds in the account. A cash advance refers to borrowing funds against a credit line that must be repaid, typically with interest, at a future time in exchange for receiving cash at the present time.

The ATM transfers the transaction requests to the payment network 120 for processing. The payment network 120 is communicatively coupled to the ATMs and the financial institution networks 140 to facilitate processing of ATM transactions. The payment network 120 can route transaction requests from the ATMs 110 to the appropriate financial institution network based on the transaction information included in the transaction request and can route transaction responses from the financial institution network to the ATMs 110. The payment network 120 can include debit switches 122. The debit switches 122 of the payment network 120 can be communicatively connected to each other to facilitate the transfer of information between the debit switches 122 of the payment network 120.

The debit switches 122 are electronic devices in the payment network 120 for routing ATM transaction requests and ATM transaction responses. The debits switches 122 interface with the ATMs 110 to provide initial processing of a transaction request by the payment network 120 and to forward a transaction response to the ATMs 110. The debit switches 122 are configured to route the transaction requests through the payment network 120 and ultimately to the appropriate one of the financial institution networks 140. The debit switches 122 can use transaction information included in the transaction request to determine how a transaction request should be routed. For example, the debit switches 122 can use at least a portion of the card number, such as a bank identification number (BIN), read from the user's credit card or debit card by the ATM. A BIN typically includes the first six numbers of a credit card number or a debit card number and can identify the financial institution that issued the transaction card, as well as the type of transaction card being used (e.g., credit card, debit card). In some embodiments, the debit switches 122 can use transaction routing tables and/or an account association tables, which can be stored in the debit switches 122 and/or stored separate from the debit switches in one or more database devices 124 that are accessible by the debit switches 122, to determine the routing path and to determine to which one of the financial institution networks 140 the transaction requests should be routed. The transaction routing table can include route information identifying one or more routes a transaction request and/or transaction response can travel to reach a destination, such as a financial institution network or an ATM. The account association table includes account information, such as card numbers, account numbers, PINs, security codes, card holder names, and the like. Accounts included in the account association table can allow a user to perform non-traditional ATM transactions.

The financial institution networks 140 can include one or more servers 142 to receive and process the transaction requests routed to them from the payment network 120, and to generate transaction responses to the transaction requests in accordance with rules and/or other predetermined parameters established by the financial institutions associated with the financial institution networks. The servers 142 are implemented using computing devices. Card holders can have accounts, such as demand deposit accounts 144 including checking accounts and/or saving accounts, and/or can have credit card accounts 146 with one or more of the financial institutions associated with the financial institution networks 140. A demand deposit account is a type of an account in which an account holder's funds are held and from which the account holder can withdraw funds on demand. A credit card account is a type of an account having a credit line that an account holder can draw against without a present requirement that the account holder have available funds. A credit card account holder must repay the funds borrowed against the credit line and in some instance must be interest on the funds. The account can be managed and maintained by servers 142 of the financial institution networks 140.

The financial institution networks 140 can determine whether to process or deny/block the transaction requests received from the payment network 120. If the transaction is denied, a transaction response corresponding to the denial is transmitted to the ATM via the payment network 120. If the transaction request is accepted, a transaction response corresponding to the acceptance is transmitted to the ATM via the payment network 120. If the transaction request is approved, the financial institution can update the card holder's account to reflect the transaction. For example, if a user withdraws funds from a demand deposit account, the financial institution network can deduct the amount of the funds from the user's demand deposit account. Upon relaying the transaction response to the ATM, the ATM performs the service requested from the user, such as, for example, dispensing funds, accepting funds for deposit, providing an account balance, providing an account statement, and the like.

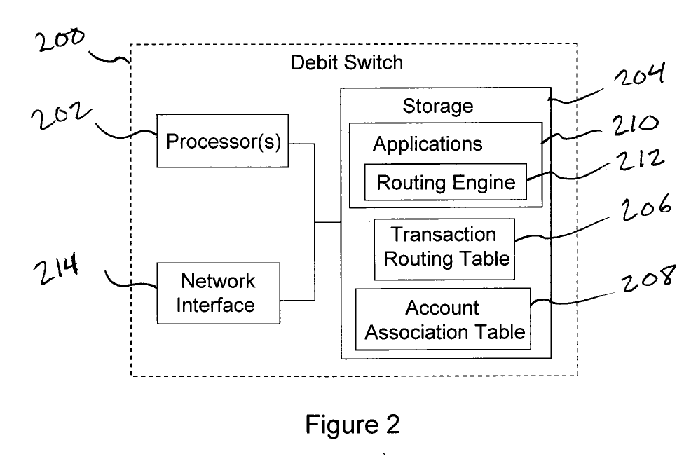

FIG. 2 is an exemplary block diagram of a debit switch 200, which can be implemented in the system 100 for one or more of the debit switches 122 (FIG. 1). The debit switch 200 can be a computing device configured to transfer and route information based on transaction information and routing parameters. In the illustrated embodiment, the debit switch 200 includes one or more controllers or processors 202 (hereinafter “processors 202”), such as central processing unit (CPU), and storage 204 for storing data, such as transaction information, transaction routing parameters and/or tables, and instructions, such as instructions for facilitating routing of transaction requests and transaction responses. For example, storage 204 can store transaction routing table 206 and/or account association table 208. The storage 204 can include computer readable medium technologies, such as a floppy drive, hard drive, tape drive, Flash drive, optical drive, read only memory (ROM), random access memory (RAM), and the like.

Applications 210, such as a routing engine 212, for facilitating processing and routing of transaction requests and transaction responses between the ATMs and the financial institution networks, can be resident in the storage 204. The storage 204 can be local and/or remote to the debit switch 200.

The routing engine 212 can interface with a transaction routing table 206 and/or the account association table 208 stored in the storage 204 to determine how to route the transaction requests and responses. The routing engine 212 can extract account information from the transaction request, including a BIN associated with the card number, to determine the identity of the issuing financial institution. An issuer or issuing financial institution refers a bank that issues credit cards and/or debit cards to an account holder for accounts that the account holder has with the financial institution. A non-issuer refers to a financial institution, such as a bank, that did not issue the particular transaction card being used in the ATM transaction.

The routing engine 212 can also extract a type of transaction being requested in the transaction request. In some embodiments, the routing engine 212 can naively transfer the transaction request to the financial institution network associated with the issuing financial institution, which is referred to herein as an “issuing financial institution network”. In some embodiments, the routing engine 212 can determine whether the type of transaction being request can be performed based on the account information included in the transaction request.

For embodiments in which the transaction requests are naively routed to the issuing financial institution network, the routing engine 212 identifies the issuing financial institution associated with the transaction card (e.g., debit card or credit card) using the BIN of the card number read by the ATM. Based on the BIN, the routing engine determines the appropriate path through the payment network to the issuing financial institution network. When the issuing financial institution network receives the transaction request from the payment network, the issuing financial institution network processes the transaction request to determine whether the requested transaction should be performed.

For embodiments in which the routing engine 212 can determine whether the transaction can be performed, the routing engine 212 identifies the issuing financial institution associated with the transaction card (e.g., debit card or credit card) read by the ATM using the BIN of the card number. Using the BIN, the routing engine 212 can determine a type of transaction card (e.g., credit or debit card) being used to initiate the transaction request as well as the issuer of the transaction card. For example, the payment network can maintain a list of BINs associated with credit cards and a list of BINs associated with debit cards in the transaction routing table, and the routing engine 212 of the debit switch 200 can access the lists to determine whether the BIN included in the transaction request is associated with a debit card or a credit card. The routing engine 212 extracts the type of transaction (e.g., cash withdrawal, cash advance) being requested in the transaction request and using this information with the identified type of card, the routing engine 212 can determine whether the transaction request should be denied or processed. If the transaction request is denied, the debit switch 200 can send a response to the ATM denying the transaction. Otherwise, the transaction request can be forwarded to the appropriate financial institution for processing.

The debit switch 200 includes a network interface 214 for communicating with other components of the payment network, such as other debit switches, as well as with the ATMs and the financial institution networks. The processor 202 operates to execute instructions included in the applications 210 to facilitate operation of the debit switch to process transaction requests from an ATM and transaction responses from a financial institution network.

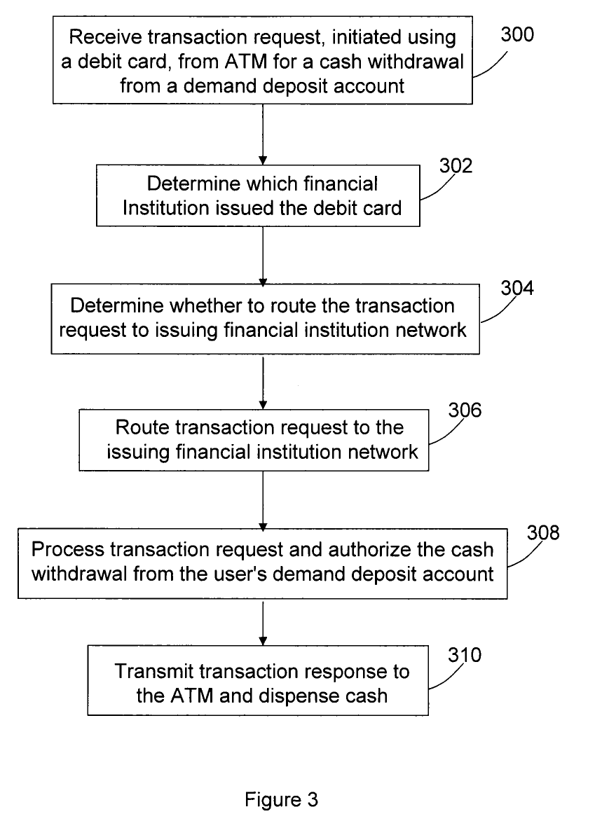

FIG. 3 is an exemplary ATM transaction flowchart for an ATM transaction using a debit card. In an exemplary debit card transaction, a user can present a debit card to the ATM, which can prompt the user for a PIN. Upon entry of the PIN, the ATM can display a list of options selectable by the user. The list of the options can include, for example, cash withdrawal, deposit funds, check balance, review statement, cash advance, and the like. In the present example, the user selects the withdraw cash option, and the ATM transmits a transaction request to the payment network (300). The transaction request can include account information, such as an account number, card holder name, security code, and the like, read from the debit card, and can identify that the user has selected the cash withdrawal option.

Upon receiving the transaction request, a debit switch of the payment network determines which financial institution issued the debit card (302) and determines whether to route the transaction request to the issuing financial institution network (304). In the present example, the debit switch routes the transaction request to the issuing financial institution network that maintains the user's demand deposit account (306). The financial institution network processes the transaction request using one or more servers and authorizes the cash withdrawal from the user's demand deposit account (308). A transaction response is transmitted to the ATM, via the payment network, and the ATM completes the transaction by dispensing cash to the user (310).

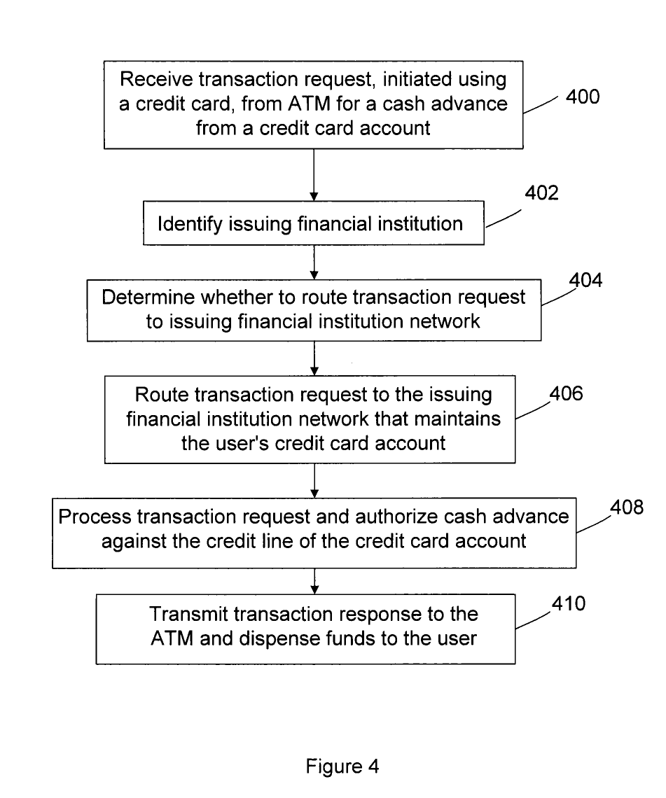

FIG. 4 is an exemplary ATM transaction flowchart for an ATM transaction using a credit card. In an exemplary credit card transaction, a user can present a credit card to the ATM, which can read the credit card and prompt the user for a PIN. Upon entry of the PIN, the ATM can display the list of options selectable by the user. In the present example, the user selects a cash advance option from the ATM prompt, and the ATM transmits a transaction request to the payment network (400). The transaction request can include account information, such as an account number, the card holder name, a security code, and the like, read from the credit card, and can identify that the user has selected the cash advance option.

Upon receiving the transaction request, the debit switch of the payment network identifies the financial institution that issued the credit card (402) and determines whether to route the transaction request to the issuing financial institution network (404). In the present example, the debit switch routes the transaction request to the issuing financial institution network that maintains the user's credit card account (406). The issuing financial institution network processes the transaction request and authorizes the cash advance against the credit line of the credit card account (408). A transaction response is transmitted to the ATM, via the payment network, and the ATM completes the transaction by dispensing funds to the user (410).

The ATM transaction system can be configured to facilitate non-traditional ATM transactions, which would conventionally be denied. For example, the payment network and/or participating financial institution networks can be configured to facilitate cash withdrawals from a demand deposit account when a user presents a credit card, issued for a credit card account, at the ATM, and can facilitate cash advances from a credit line when a user presents a debit card, issued for a demand deposit account. To achieve this, the debit switches of the payment network can be configured with enhanced routing capabilities and/or the servers of participating financial institution networks can be updated to permit these non-traditional ATM transactions. In some embodiments, the system can be configured to facilitate non-traditional ATM transactions for which an issuing financial institution maintains both a demand deposit account and a credit card account for a user. When a financial institution maintains both types of accounts (i.e. a demand deposit account and a credit card account) for a user, the financial institution typically issues a debit card for the demand deposit account, with only the account information for the debit card embedded therein, and a credit card for the credit card account, with only the account information for the credit card embedded therein. In some embodiments, the system can be configured to facilitate non-traditional ATM transaction for which a user's demand deposit account and credit card account are maintained by different financial institutions, where one financial institution issues a debit card for the demand deposit account and another financial institution issues a credit card for the credit card account.

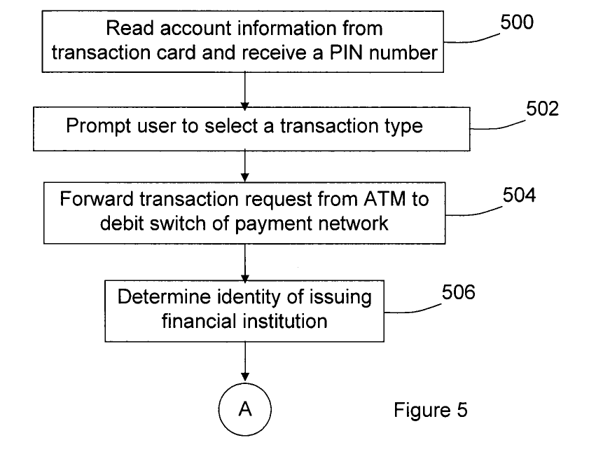

FIG. 5 is an exemplary ATM transaction flowchart illustrating processing a transaction request using a different account than the account for which the transaction card that initiated the request was issued. The ATM can read account information, including a card number and/or account number, from a transaction card issued for a first type of account (e.g., a credit card account or a demand deposit account) and can receive a PIN number from the user (500). After the ATM reads the card information from the transaction card and the user enters the PIN, the ATM can prompt the user to select a transaction type from a list of transaction options (502). In the present example, the user selects a transaction type from the prompt displayed by the ATM that cannot be processed using the type of account for which the transaction card was issued. The ATM can forward a transaction request, which can include the account information read from the transaction card and the selected transaction type, to the payment network (504). A debit switch of the payment network can receive the transaction request and can determine the identity of the issuing financial institution (i.e., the issuer of the transaction card) from at least a portion of the card number, such as a BIN of the card number (506). The debit switch can use a transaction routing table stored in the payment network to identify the issuing financial institution. At this point, the system can process the transaction request using one or more embodiments discussed in more detail below.

In some embodiments, the ATM can read account information from a credit card issued for credit card account, including a card number and/or account number, and can receive a PIN number from the user. When the user selects a cash withdrawal option, the cash withdrawal cannot be processed using the credit card account for which the transaction card was issued.

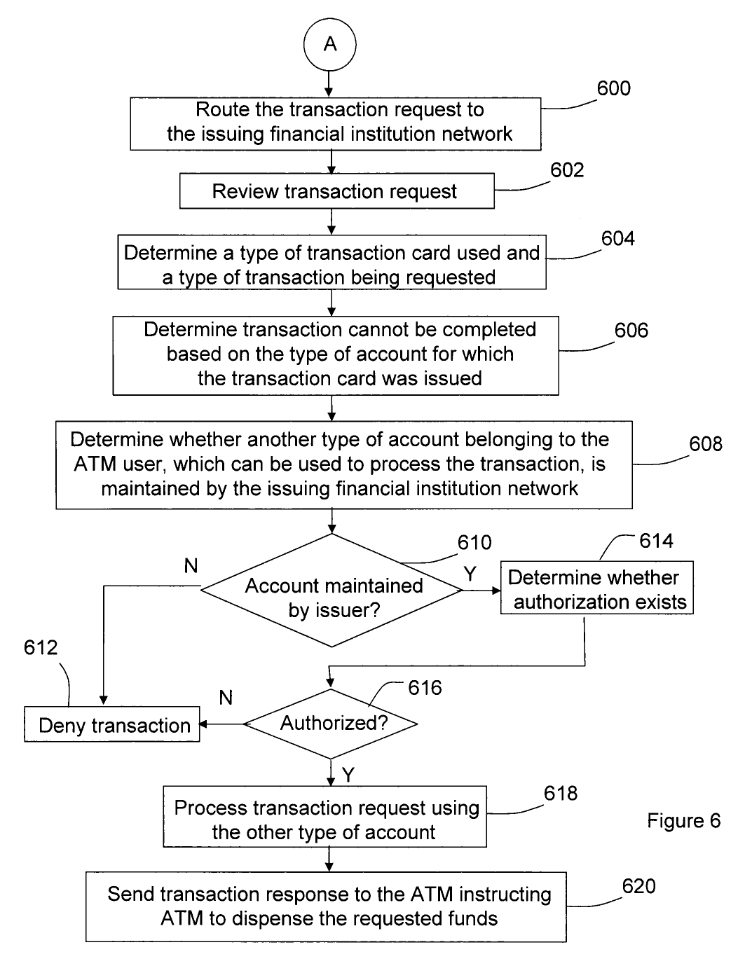

When the credit card holder has a credit card account and a demand deposit account with the issuing financial institution (i.e. the financial institution that issued the credit card), as shown in FIG. 6, the debit switch of the payment network can route the transaction request to the issuing financial institution network, rather than denying the request to withdraw cash from a demand deposit account because a credit card was read by the ATM (600). In some embodiments, the debit switch can route a transaction request to the financial institution that issued the credit card without regard to the existence of a demand deposit account. The servers of issuing financial institution networks can review the account information and the transaction type included in the transaction request (602).

Upon determining that a credit card has been used to initiate the transaction and that a cash withdrawal (e.g., a type of transaction) has been requested (604), the issuing financial institution network, via one or more of the servers, determines that the transaction requested cannot be completed using the credit card account maintained by the issuing financial institution network (606). The one or more servers of the issuing financial institution network can determine whether a demand deposit account belonging to the ATM user is also maintained by the issuing financial institution network (608). If a demand deposit account is not maintained by the issuer (610), the servers deny the transaction and transmit a transaction response to the ATM denying the transaction request (612).

Otherwise, the servers of the financial institution network can determine whether the credit card holder has authorized cash withdrawal from the demand deposit account in response to the presentation of the credit card at the ATM (614). For example, to allow a user to withdraw funds from a demand deposit account when the user presents a credit card, the user may be required to preauthorize such transactions. This preauthorization can be stored and maintained by the one or more servers of the issuing financial institution network. If the servers of the issuing financial network identify such preauthorization (616), the issuing financial institution network processes the transaction request using the demand deposit account (618) and sends a transaction response to the ATM instructing the ATM to dispense the requested funds (620). Otherwise, the servers transmit a transaction response to the ATM denying the transaction request (612).

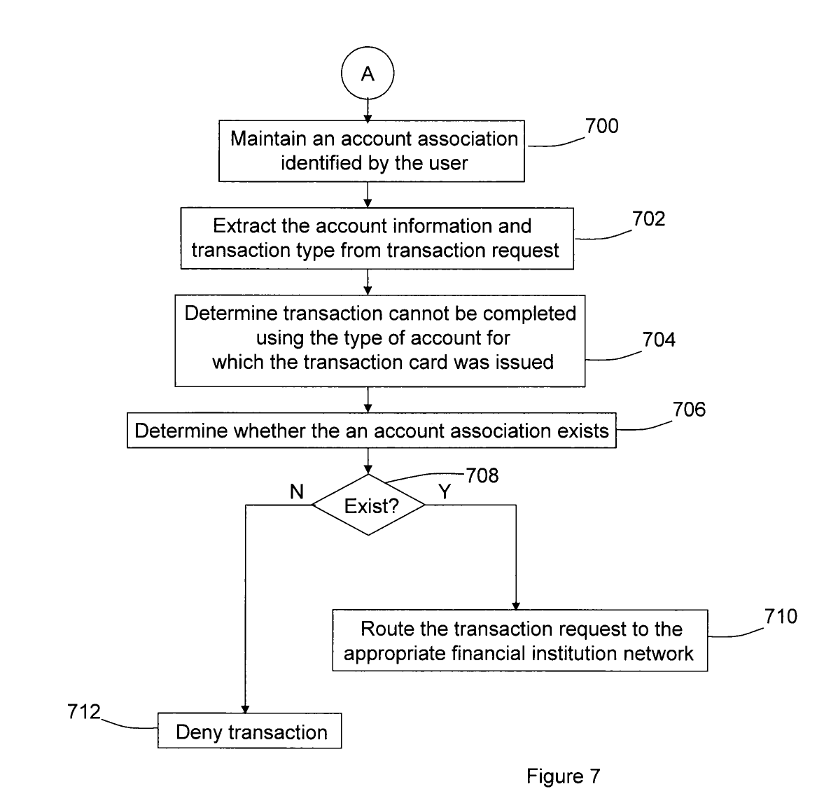

In some embodiments, referring to FIG. 7, the payment network can maintain an account association identified by the user (700). For example, the user can identify a demand deposit account from which funds can be withdrawn using a credit card at an ATM. The account association can be maintained in an account association table of the payment network. Account associations can include a card number, an account number, issuer identification, PINS, security codes, and the like, for each associated account. The account associations can be verified by the payment network to ensure the user has the authority to withdraw funds from the demand deposit account using a credit card. In these embodiments, the debit switch of the payment network can extract the account information and transaction type from the transaction request (702).

Upon determining that a credit card has been used to initiate the transaction and that the transaction type cannot be completed using the credit card account for which the credit card was issued (704), the debit switch of the payment network can perform a look-up in the account association table to determine whether the an account association exists (706). If the account association exists (708), the debit switch can route the transaction request to the appropriate financial institution network (710). Otherwise, the transaction is denied (712). In some embodiments, the appropriate financial institution network can be the financial institution that issued the credit card. In some embodiments, the financial institution can be different from the financial institution that issued the credit card such that the transaction request is routed to a non-issuing financial institution network.

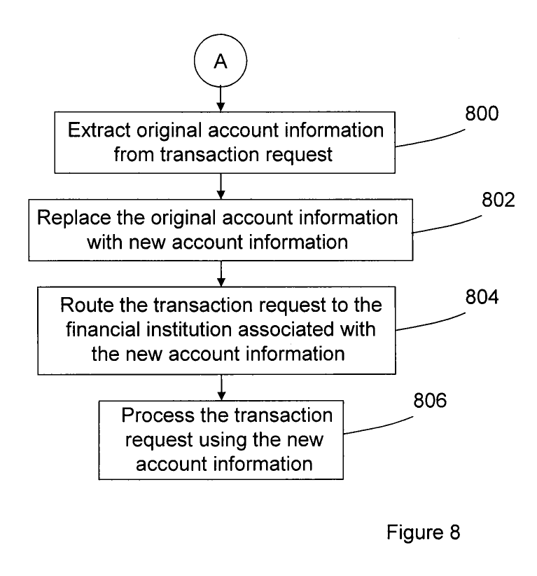

In some embodiments, referring to FIG. 8, to facilitate ATM transactions using an account that is different than the account corresponding to the transaction card used to initiate the transaction, the debit switch can extract the account information read from the credit card (i.e. the original account information) (800) and replace the original account information in the transaction request with new account information corresponding to the associated account retrieved from the account association table (802). For example, the debit switch can replace a card number and PIN of the original account information in the transaction request with a card number and PIN associated with the new account. After the debit switch replaces the original account information with the new account information, the debit switch can route the transaction request to the financial institution associated with the new account information, which can be the financial institution that issued the transaction card or can be a financial institution that did not issue the transaction card (804). Once the transaction request reaches the destination financial institution network (i.e. the financial institution network associated with the new account information), the servers of the destination financial institution network are unaware that the debit switch has replaced the original account information with the new account information. As a result, the servers of the destination financial institution network process the transaction request normally as if the user had presented a transaction card at the ATM that was issued by the destination financial institution and that corresponded to the new account information inserted into the transaction request modified by the debit switch (806).

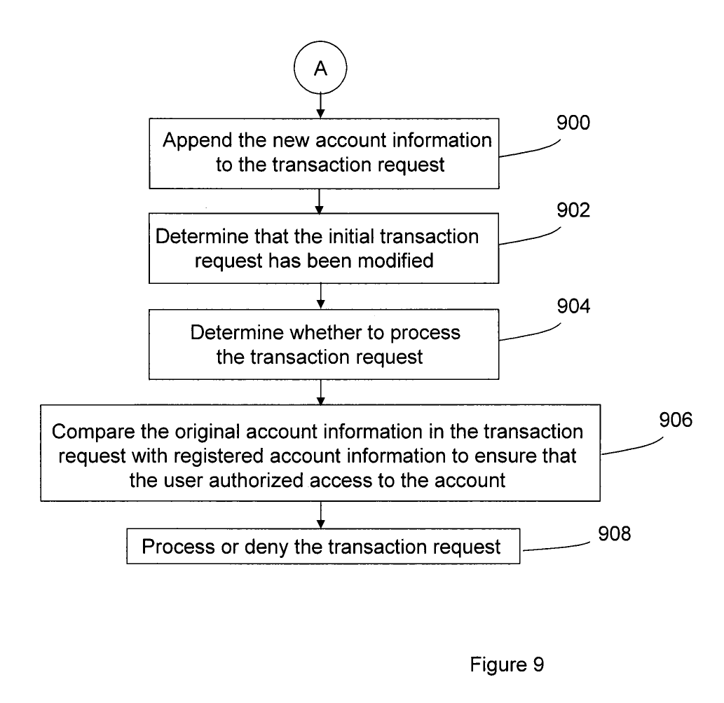

In some embodiments, referring to FIG. 9, the debit switch can append the new account information to the transaction request to indicate that the transaction request has been modified by the debit switch (900). In these embodiments, the servers of destination financial institution network can determine that the initial transaction request has been modified by the debit switch (902) and can determine whether to process the transaction request using the modified transaction request (904). For example, the servers of the destination financial institution network can require that the user register transaction card numbers for transaction cards that were not issued by the destination financial institution for account for which the transaction card was issued. In some embodiments, the destination financial institution does not maintain the account for which the transaction was issued. In some embodiments, the destination financial institution maintains the account for which the transaction card was issued. The registered card number can be used to interface with the account maintained by the financial institution network so that the financial institution network can verify the transaction request before performing the transaction. The servers of the financial institution network can access the account based on the appended account information and can compare the original account information with the registered account information to ensure that the user authorized access to the account in response to the use of the transaction card at the ATM (906). In response to the comparison, the servers can process or deny the transaction request (908).

Although FIGS. 6-9 are described above with respect to a cash withdrawal from a demand deposit account when a credit card issued for a credit card account is presented, those skilled in the art will recognize that other transactions can be performed using the ATM transaction system. As an example, referring again to FIGS. 6-9, the ATM transaction system can perform a cash advance transaction from a credit card account when a debit card issued for a demand deposit account is presented by a user at the ATM.

Referring again to FIG. 6, in some embodiments, when the debit card holder has a demand deposit account (e.g., a type of account for which the debit card was issued) and a credit card account (e.g., another type of account) with the issuing financial institution (i.e. the financial institution that issued the debit card), the debit switch of the payment network can route the transaction request to the issuing financial institution network, rather than denying the request for a cash advance from a credit card account because a debit card was read by the ATM (600). In these embodiments, the servers of issuing financial institution networks can review the account information and the transaction type included in the transaction request (602).

Upon determining that a debit card (e.g., a type of transaction card) has been used to initiate the transaction and that a cash advance (e.g., a type of transaction) has been requested (604), the issuing financial institution network, via one or more of the servers, determines that the transaction requested cannot be completed using the demand deposit account (e.g., a type of account for which the debit card was issued) maintained by the issuing financial institution network (606). The one or more servers of the issuing financial institution network can determine whether a credit card account (e.g., another type of account) belonging to the ATM user, which can be used to process the cash advance transaction, is maintained by the issuing financial institution network (608). If a credit card account is not maintained by the issuer (610), the servers deny the transaction and transmit a transaction response to the ATM denying the transaction request (612). Otherwise, the servers of the financial institution network can determine whether the debit card holder has authorized cash advance from the credit card account in response to the presentation of the debit card at the ATM (614). For example, to allow a user wishes to receive a cash advance from a credit card account when the user presents a debit card, the user may be required to preauthorize such transactions. This preauthorization can be stored and maintained by the one or more servers of the issuing financial institution network. If the servers of the issuing financial network identify such preauthorization (616), the issuing financial institution network processes the transaction request using the credit card account (618) and sends a transaction response to the ATM instructing the ATM to dispense the requested funds (620). Otherwise, the servers transmit a transaction response to the ATM denying the transaction request (612).

With reference again to FIG. 7, the payment network can maintain an account association identified by the user to facilitate a cash advance in response to a debit card issued for a demand deposit account being presented at an ATM (700). For example, the user can identify a credit card account from which a cash advance can be received using a debit card at an ATM. The account association can be maintained in an account association table of the payment network. Account associations can include a card number, an account number, issuer identification, PINS, security codes, and the like, for each associated account. The account associations can be verified by the payment network to ensure the user has the authority to receive a cash advance from an identified credit card account using a debit card. In these embodiments, the debit switch of the payment network can extract the account information and transaction type from the transaction request (702).

Upon determining that a debit card has been used to initiate the transaction and that the transaction type cannot be completed using the demand deposit account for which the debit card was issued (704), the debit switch of the payment network can perform a look-up in the account association table to determine whether the an account association exists (706). If the account association exists (708), the debit switch can route the transaction request to the appropriate financial institution network (710). Otherwise, the transaction request is denied. In some embodiments, the appropriate financial institution network can be the financial institution that issued the debit card. In some embodiments, the financial institution can be different from the financial institution that issued the debit card such that the transaction request is routed to a non-issuing financial institution network.

In some embodiments, referring to FIG. 8, to facilitate ATM transactions using an account that is different than the account corresponding to the debit card used to initiate the transaction, the debit switch can extract the account information read from the debit card (i.e. the original account information) (802) and replace the original account information in the transaction request with new account information corresponding to the associated credit card account retrieved from the account association table (804). After the debit switch replaces the original account information with the new account information, the debit switch can route the transaction request to the financial institution associated with the new account information, which can be the financial institution that issued the debit card or can be a financial institution that did not issue the debit card (806). Once the transaction request reaches the destination financial institution network (i.e. the financial institution network associated with the new account information), the servers of the destination financial institution network are unaware that the debit switch has replaced the original account information with the new account information. As a result, the servers of the destination financial institution network process the transaction request using the new account information as if the user had presented a credit card at the ATM that was issued by the destination financial institution and that corresponded to the new account information inserted into the transaction request modified by the debit switch (808).

In some embodiments, referring to FIG. 9, the debit switch can append the new account information to the transaction request to indicate that the transaction request has been modified by the debit switch (900). In these embodiments, the servers of destination financial institution network can determine that the initial transaction request has been changed by the debit switch (902) and can determine whether to process the transaction request using the modified transaction request (904). For example, the servers of the destination financial institution network can require that the user register transaction card numbers that may be used to interface with the account maintained by the financial institution network so that the financial institution network can verify the transaction request before performing the transaction. The servers of the financial institution network can access the account based on the appended account information and can compare the original account information with the registered account information to ensure that the user authorized access to the account in response to the use of the transaction card at the ATM (906). In response to the comparison, the servers can process or deny the transaction request (908).

The list of the options can include, for example, withdrawal cash, deposit funds, check balance, review statement, cash advance, and the like. In the present example, the user selects the withdraw cash option, and the ATM transmits a transaction request to the payment network. The transaction request can include the account number read from the debit card and can identify that the user has selected the withdraw cash option.

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A method of processing an Automated Teller Machine (ATM) transaction comprising:
receiving a transaction request from an ATM, the transaction request including account information read from a transaction card by the ATM and a request to perform an ATM transaction, the account information corresponding to a first account and the transaction request incapable of being processed using the first account for which the transaction card was issued;
identifying a second account, the second account being a different type of account than the first account, the transaction request capable of being processed using the second account; and
processing the transaction request using the second account to perform the ATM transaction requested.

2. The method of claim 1, wherein the transaction card is a credit card issued for a credit card account, the first account is a credit card account, the second account is a demand deposit account, and the ATM transaction requested is a cash withdrawal

3. The method of claim 1, wherein the transaction card is a debit card issued for a demand deposit account, the first account is a demand deposit account, the second account is a credit card account, and the ATM transaction request is a cash advance.

4. The method of claim 1, further comprising:
routing the transaction request to a destination financial institution network associated with the second account by the debit switch for transaction processing;
receiving a transaction response from the destination financial institution network; and
forwarding the transaction response to the ATM by the debit switch, the ATM dispensing funds in response to the transaction response.

5. The method of claim 4, wherein the destination financial institution network is associated with a financial institution that issued the transaction card such that the first and second accounts are maintained by the destination financial institution network.

6. The method of claim 4, wherein the destination financial institution network is different than a financial institution network that issued the transaction card such that the first and second accounts are maintained by different financial institution networks.

7. The method of claim 1, further comprising:
replacing the account information included in the request with new account information by a debit switch in the payment network, the new account information corresponding to the second account; and
forwarding the request with the new account information to the destination financial institution network, which maintains the second account.

8. The method of claim 8, wherein the destination financial institution is unaware that the account information originally included in the request has been replaced with the new account information by the debit switch.

9. The method of claim 1, further comprising:
adding new account information to the request by a debit switch of the payment network to create a modified request, the new account information corresponding to the second account; and
forwarding the modified request to the destination financial institution network, the destination financial institution using the account information originally included in the request to validate the transaction and using the new account information included in the modified request to perform the requested transaction.

10. A computer readable medium storing instructions executable by a computing system including at least one computing device, wherein execution of the instructions implements a method for processing an Automated Teller Machine (ATM) transaction comprising:
receiving a transaction request from an ATM, the transaction request including account information read from a transaction card by the ATM and a request to perform an ATM transaction, the account information corresponding to a first account and the transaction request incapable of being processed using the first account for which the transaction card was issued;
identifying a second account, the second account being a different type of account than the first account, the transaction request capable of being processed using the second account; and
processing the transaction request using the second account to perform the ATM transaction requested.

11. The medium of claim 10, wherein the transaction card is a credit card issued for a credit card account, the first account is a credit card account, the second account is a demand deposit account, and the ATM transaction requested is a cash withdrawal

12. The medium of claim 10, wherein the transaction card is a debit card issued for a demand deposit account, the first account is a demand deposit account, the second account is a credit card account, and the ATM transaction request is a cash advance.

13. The medium of claim 10, wherein execution of the instructions implements a method further comprising:
replacing the account information included in the request with new account information by a debit switch in the payment network, the new account information corresponding to the second account; and
forwarding the request with the new account information to the destination financial institution network, which maintains the second account.

14. The medium of claim 13, wherein the destination financial institution is unaware that the account information originally included in the request has been replaced with the new account information by the debit switch.

15. The medium of claim 1, wherein execution of the instructions implements a method further comprising:
adding new account information to the request by a debit switch of the payment network to create a modified request, the new account information corresponding to the second account; and
forwarding the modified request to the destination financial institution network, the destination financial institution using the account information originally included in the request to validate the transaction and using the new account information included in the modified request to perform the requested transaction.

16. A system for processing an Automated Teller Machine (ATM) transaction comprising:
a payment network having at least one debit switch, the debit switch being configured to:
receive a transaction request from an ATM, the transaction request including account information read from a transaction card by the ATM and a request to perform an ATM transaction, the account information corresponding to a first account and the transaction request incapable of being processed using the first account for which the transaction card was issued;
identify a second account, the second account being a different type of account than the first account, the transaction request capable of being processed using the second account; and
forwarding the request to a financial institution network associated with the second account.

17. The system of claim 16, wherein the transaction card is a credit card issued for a credit card account, the first account is a credit card account, the second account is a demand deposit account, and the ATM transaction requested is a cash withdrawal

18. The system of claim 16, wherein the transaction card is a debit card issued for a demand deposit account, the first account is a demand deposit account, the second account is a credit card account, and the ATM transaction request is a cash advance.

19. The system of claim 16, wherein the debit switch is further configured to replace the account information included in the request with new account information of the second account by a debit switch in the payment network, the new account information corresponding to the second account.

20. The system of claim 16, wherein the debit switch is further configured to add new account information associated with the second account to the request by a debit switch of the payment network to create a modified request, the new account information corresponding to the second account; and
forwarding the modified request to the destination financial institution network, the destination financial institution using the account information originally included in the request to validate the transaction and using the new account information included in the modified request to perform the requested transaction.
